(19) United States
(12) Patent Application Publication
(10) Pub. No.: US 2016/0019381 A1
(43) Pub. Date: Jan. 21, 2016

(54) METHOD FOR WRITING CARD OVER THE AIR, SERVER AND SMART CARD

(71) Applicant: CHINA UNITED NETWORK COMMUNICATIONS GROUP COMPANY LIMITED, BEIJING (CN)

(72) Inventors: QUN YANG, BEIJING (CN); BINFENG YAN, BEIJING (CN); YUHUA HOU, BEIJING (CN); LING HAN, BEIJING (CN); WEI KUANG, BEIJING (CN); XIANGHUA LIU, BEIJING (CN)

(21) Appl. No.: 14/741,405

(22) Filed: Jun. 16, 2015

(30) Foreign Application Priority Data
Jul. 15, 2014 (CN) 201410336628.9

(51) Int. Cl. G06F 21/34

(52) U.S. Cl. CPC G06F 21/34

(57) ABSTRACT

The present invention provides a method for writing a card over the air, a server and a smart card, the method includes: receiving, by a server, a card writing request transmitted by a portal site, where the card writing request carries a preset number and a card writing number corresponding to a smart card to be written; acquiring first card data corresponding to the card writing number according to the card writing number; transmitting the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card, so that the smart card completes card writing over the air.

### CROSS-REFERENCE TO RELATED APPLICATION

This application claims priority to Chinese Patent Application No. 201410336628.9, filed on Jul. 15, 2014, which is incorporated herein by reference in its entirety.

### TECHNICAL FIELD

The present invention relates to information technologies and, in particular, to a method for writing a card over the air, a server and a smart card.

### BACKGROUND

Currently, smart card issuance is divided into finished card issuance and unfinished card issuance. A finished card refers to a smart card which is uniformly made by a card-making department of an operator and is written with complete card data, and the finished card needs to be issued through channels such as a business office and a sales point. The unfinished card refers to a smart card into which card data except an international mobile subscriber identification number (IMSI) is prewritten, the IMSI is written onsite when the card is sold in a province, and the unfinished card issuance also needs to be implemented by salesperson with an onsite POS machine.

In order to achieve flexibility of opening the smart card during the unfinished card issuance, complete data corresponding to a preset number is written into the card to be issued, a fixed service has been opened for the preset number, and information interaction can be performed with only a corresponding card writing server. After acquiring such an unfinished card, a subscriber can complete a card writing procedure in any area covered by a network via the preset number.

If, according to the traditional unfinished card issuance procedure, the card writing server still transmits a service available IMSI to the unfinished card, then a one-to-two correspondence where a set of network authentication keys corresponds to both the preset IMSI and the transmitted IMSI will occur. This case leads to a problem that a background system maintaining a service for writing a card over the air needs to find a new network authentication key for matching after the preset IMSI is recycled, which results in a complex process and is inconvenience to recycle the preset number.

### SUMMARY

The present invention provides a method for writing a card over the air, a server and a smart card, which are used for solving a technical problem in the prior art that a preset number is inconvenient to be recycled caused by a one-to-two correspondence between one set of network authentication keys and two sets of IMSIs which is formed in a process of writing a card over the air via a preset number, during unfinished card issuance.

In one aspect, embodiments of the present invention provide a method for writing a card over the air, including:

receiving, by a server, a card writing request transmitted by a portal site, where the card writing request carries a preset number and a card writing number corresponding to a smart card to be written;

acquiring, by the server, first card data corresponding to the card writing number according to the card writing number;

transmitting, by the server, the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card to enable the smart card to complete card writing over the air.

In another aspect, embodiments of the present invention provide a method for writing a card over the air, including:

receiving, by a smart card, first card data transmitted by a server via a preset number set in the smart card, where the smart card carries original card data, in which an original authentication key parameter is contained, corresponding to the preset number and a first authentication key parameter;

replacing, by the smart card, except the original authentication key parameter, the original card data corresponding to the preset number with the first card data correspondingly, and replacing the original authentication key parameter with the first authentication key parameter correspondingly to complete card writing over the air.

In another aspect, embodiments of the present invention provide a server, including:

a receiving module, configured to receive a card writing request transmitted by a portal site, where the card writing request carries a preset number and a card writing number corresponding to a smart card to be written;

a processing module, configured to acquire first card data corresponding to the card writing number according to the card writing number;

a transmitting module, configured to transmit the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card to enable the smart card to complete card writing over the air.

In another aspect, embodiments of the present invention provide a smart card, including:

a receiving module, configured to receive first card data transmitted by a server via a preset number set in the smart card, where the smart card carries original card data, in which an original authentication key parameter is contained, corresponding to the preset number and a first authentication key parameter;

a processing module, configured to replace, except the original authentication key parameter, the original card data corresponding to the preset number with the first card data correspondingly, and replace the original authentication key parameter with the first authentication key parameter correspondingly to complete card writing over the air.

The present invention provides a method for writing a card over the air, a server and a smart card. A server receives a card writing request transmitted by a portal site, where the card writing request carries a preset number and a card writing number corresponding to a smart card to be written; the server acquires first card data corresponding to the card writing number according to the card writing number; the server transmits the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card, so as to enable the smart card to complete the card writing over the air. The solution can effectively solve a defect in the prior art that the preset number is inconvenient to be recycled caused by a one-to-two correspondence between one set of network authentication keys and two sets of IMSIs which is formed in a process of writing a card over the air via a preset number, during unfinished card issuance.

### BRIEF DESCRIPTION OF DRAWINGS

FIG. 1 is a flow chart of a method for writing a card over the air according to an embodiment of the present invention;

FIG. 2 is a flow chart of a method for writing a card over the air according to another embodiment of the present invention;

FIG. 3 is a flow chart of a method for writing a card over the air according to still another embodiment of the present invention;

FIG. 4 is a schematic structural diagram of a server according to an embodiment of the present invention;

FIG. 5 is a schematic structural diagram of a smart card according to an embodiment of the present invention.

### DESCRIPTION OF EMBODIMENTS

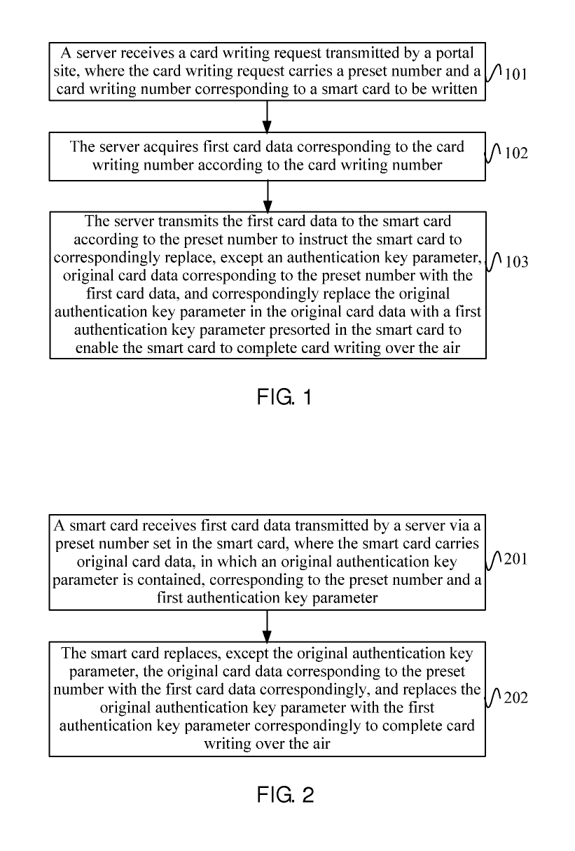

FIG. 1 is a flow chart of a method for writing a card over the air according to an embodiment of the present invention, the method for writing the card over the air specifically includes:

S101, a server receives a card writing request transmitted by a portal site, where the card writing request carries a preset number and a card writing number corresponding to a smart card to be written;

A subscriber acquires a smart card issued by an operator by purchase, where the smart card is preset with a preset number and a complete set of card data corresponding thereto, including: an integrate circuit card identity (ICCID), an MSISDN, an international mobile subscriber identification number (IMSI), a short message service platform (SMSP), a personal identification number (PIN1, PIN2), a PUK1, a PUK2, an authentication key (Key identifier, KI), an A4, a key sequence (OPc), etc. A special service has been opened for the preset number when the preset number is issued by the operator, unlike a number used in normal network communications, communication authorities of the preset number are limited, when a smart card having a preset number built in is placed into a mobile phone for use, the smart card can communicate with only the server through a short message or in other forms via a preset communication module, but cannot communicate with other normal numbers in an existing mobile communication network through making calls or transmitting and receiving messages.

The server transmits card writing data required for a normal opening of the smart card by communicating with the preset number in the issued smart card. When an existing mobile network side transmits card writing data to the smart card, an transmitted IMSI together with other card data preset in the smart card will form new complete card writing data, which will lead to a one-to-two correspondence formed between one set of network authentication key parameters and two IMSIs. In this embodiment, in order to facilitate separate management of card data corresponding to a card writing number and card data corresponding to a preset number, in this embodiment, complete card data will be reconfigured for the card writing number, and will be transmitted to the smart card via a card writing server. Whereas during actual transmission of the card data, there will be a risk that some important data in the card writing data, such as the KI or the OPc described above, is leaked or is illegally intercepted and embezzled. Thus, in this embodiment, the card data transmitted by the card writing server will not include authentication key parameters such as the KI and the OPc, instead, in the smart card, besides the preset number and a corresponding set of complete card data, i.e., initial card data, another set of first authentication key parameters for network authentication, which also includes the KI and the OPc, is also preset in advance. The first authentication key parameters may be combined with the card writing data, which is transmitted by the server and does not include an authentication key parameter, to form a set of complete card data, and a number corresponding to the complete card data can realize communications with other numbers in the mobile communication network.

Specifically, after acquiring the smart card preset with the preset number and the first authentication key parameter, the subscriber may get access to the portal site through placing the smart card into a mobile phone and logging into a specified client software via the preset number, or get access to the portal site directly through the internet. On the portal site, the subscriber inputs the preset number and submits information for identity review. After passing the identity review, a subscriber may select a new number provided on the portal site as a card writing number which is about to be written into the above smart card and submits a request for opening an account. After receiving the account-opening request, the portal site transmits a card writing request to the server. The card writing request carries the preset number corresponding to the smart card to be written and the card writing number selected by the subscriber on the portal site.

Meanwhile, the subscriber may also select on the portal site a service and a type of package required to be opened for the card writing number corresponding to the smart card to be written, so as to transmit a corresponding service request to a headquarter code-number management and charging support system through the server to open a corresponding service for the smart card to be written.

S102, the server acquires first card data corresponding to the card writing number according to the card writing number;

The server extracts a corresponding card writing number from the card writing request transmitted by the portal site, and acquires first card data corresponding to the card writing number according to the card writing number. The first card data may be specifically a set of incomplete card data corresponding to the card writing number, which is used for the card writing number to perform a service in the mobile communication network and does not include an authentication key parameter, the first card data covers all other data items of the complete card data described above except the authentication key parameter. Reference may be made to contents described above for specific data items, which will not be repeated herein.

Specifically, the server may locally set a card writing number-first card data correspondence table in advance, there is a one-to-one correspondence between each card writing number in the card writing number-first card data correspondence table and a card writing number provided on the portal site. After the server extracts a corresponding card writing number from the card writing request transmitted by the portal site, searches for the same card writing number in the card writing number-first card data correspondence table, and determine first card data corresponding to the searched card writing number as the first card data corresponding to the card writing number in the card writing request.

Or, the server transmits the card writing request to a customer relationship management system (CRM) directly, and the CRM transmits the first card data corresponding to the card writing number to the server and an electronic sales service management system (ESS). After the ESS opens the card writing number, the server may transmit the card writing number and the corresponding first card data to the smart card.

S103, the server transmits the first card data to the smart card according to the preset number to instruct the smart card to correspondingly replace, except an authentication key parameter, original card data corresponding to the preset number with the first card data, and correspondingly replace the original authentication key parameter in the original card data with a first authentication key parameter presorted in the smart card to enable the smart card to complete card writing over the air.

After acquiring the first card data corresponding to the card writing number, the server transmits the first card data to the smart card via the preset number. After receiving the first card data, the smart card replaces remained original card data excluding the original authentication key parameter (including the authentication key KI and the key sequence OPc corresponding to the preset number) in the original card data corresponding to the preset number in the smart card with corresponding data in the first card data one by one. Meanwhile, the original authentication key parameter in the original card data is replaced with a first authentication key parameter prestored in the smart card correspondingly. The first card data and the first authentication key parameter together form card data corresponding to the card writing number and are written into the smart card, so that the smart card completes the process of writing a card over the air. The smart card which succeeds in completing the card writing over the air can perform a normal mobile communication service via the card writing number.

According to the method for writing a card over the air provided in the present invention, a server receives a card writing request transmitted by a portal site, where the card writing request carries a preset number and a card writing number corresponding to a smart card to be written; the server acquires first card data corresponding to the card writing number according to the card writing number; the server transmits the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card, so as to enable the smart card to complete the card writing over the air. The solution can effectively solve a defect in the prior art that the preset number is inconvenient to be recycled caused by a one-to-two correspondence between one set of network authentication keys and two sets of IMSIs which is formed in a process of writing a card over the air via a preset number, during unfinished card issuance.

FIG. 2 is a flow chart of a method for writing a card over the air according to another embodiment of the present invention, an executive agent of the embodiment is a communication smart card installed, for example, in a smart phone. As shown in FIG. 2, the method for writing the card over the air specifically includes:

S201, a smart card receives first card data transmitted by a server via a preset number set in the smart card, where the smart card carries original card data, in which an original authentication key parameter is contained, corresponding to the preset number and a first authentication key parameter;

After acquiring a smart card issued by an operator by purchase, a subscriber may transmit a card writing request to a server which is provided in the network for performing a card writing service via a portal site provided by the operator, the card writing request carries a preset number and a card writing number corresponding to the smart card to be written, to request the server to write card writing data that enables the smart card to be used normally in the mobile network to the smart card held by the subscriber. After receiving the card writing request transmitted by the portal site, the server acquires first card data corresponding to the card writing number according to the card writing number corresponding to the smart card to be written as carried in the card writing request; and transmits the first card data to the smart card via the preset number carried in the card writing request. Reference may be made to steps 101-403 of the embodiment as shown in FIG. 1 for specific steps of: the receiving, by the server, the card writing request transmitted by the portal site; the acquiring, by the server, the first card data corresponding to the card writing number according to the card writing request, and the transmitting, by the server, the first card data to the smart card according to the preset number, which will not be repeated herein.

Besides the original authentication key parameter corresponding to the preset number, the smart card is also prestored with a first authentication key parameter; the first authentication key parameter is another set of authentication key parameters preset in the smart card before the smart card is issued and which is different from the original authentication key parameter in the original card data, the authentication key KI and the key sequence OPc are also included. The first authentication key parameter may be used to realize authentication of a communication network when the smart card performs normal communications in the mobile network, thereby ensuring that a number corresponding to the smart card can perform service communications in the mobile network.

S202, the smart card replaces, except the original authentication key parameter, the original card data corresponding to the preset number with the first card data correspondingly, and replaces the original authentication key parameter with the first authentication key parameter correspondingly to complete card writing over the air;

After receiving the first card data, the smart card replaces, except the original authentication key parameter (including the authentication key KI and the key sequence OPc), the original card data corresponding to the preset number in the smart card with corresponding data in the first card data one by one. Meanwhile, the original authentication key parameter in the original card data is replaced with a first authentication key parameter prestored in the smart card correspondingly. The first card data and the first authentication key parameter together form card data corresponding to the card writing number and are written into the smart card, so that the smart card completes the process of writing a card over the air. The smart card which succeeds in completing the card writing over the air can perform a mobile communication service via the card writing number.

According to the method for writing a card over the air provided in the present invention, a smart card receives first card data transmitted by a server via a preset number set in the smart card, where the smart card carries original card data, in which an original authentication key parameter is contained, corresponding to the preset number and a first authentication key parameter; the smart card correspondingly replaces, except the original authentication key parameter, the original card data corresponding to the preset number with the first card data, and correspondingly replaces the original authentication key parameter with the first authentication key parameter to complete the card writing over the air. The solution can effectively solve a defect in the prior art that the preset number is inconvenient to be recycled caused by a one-to-two correspondence between one set of network authentication keys and two sets of IMSIs which is formed in a process of writing a card over the air via a preset number, during unfinished card issuance.

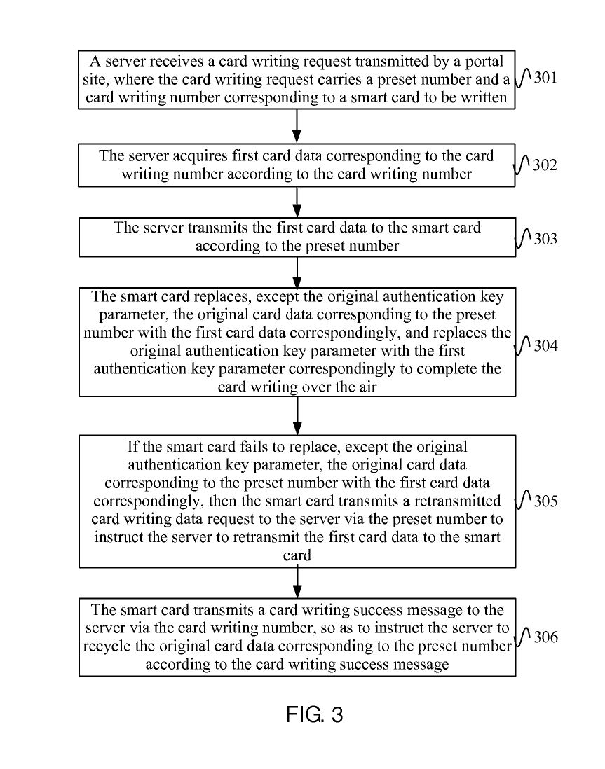

FIG. 3 is a flow chart of a method for writing a card over the air according to still another embodiment of the present invention, an executive agent of the embodiment relates to the server as shown in FIG. 1 and the communication smart card which is installed, for example, in a smart phone as shown in FIG. 2. As shown in FIG. 3, the method for writing the card over the air is a specific implementation of the methods for writing the card over the air as shown in FIG. 1 and FIG. 2, the method specifically includes:

S301, a server receives a card writing request transmitted by a portal site, where the card writing request carries a preset number and a card writing number corresponding to a smart card to be written;

S302, the server acquires first card data corresponding to the card writing number according to the card writing number;

S303, the server transmits the first card data to the smart card according to the preset number;

Reference may be made to corresponding contents of the steps 101-403 for a specific implementation process of the steps 301-303, which will not be repeated herein.

Specifically, in step 303, the server may transmit the first card data to the smart card by transmitting over-the-air (OTA) information, and may also perform encryption to the first card data during the transmitting process, to ensure that the first card data will not be leaked during the transmission process.

S304, the smart card replaces, except the original authentication key parameter, the original card data corresponding to the preset number with the first card data correspondingly, and replaces the original authentication key parameter with the first authentication key parameter correspondingly to complete the card writing over the air; reference may be made to corresponding contents of the step 202 for a specific implementation process of this step.

S305, if the smart card fails to replace, except the original authentication key parameter, the original card data corresponding to the preset number with the first card data correspondingly, then the smart card transmits a retransmitted card writing data request to the server via the preset number to instruct the server to retransmit the first card data to the smart card;

Specifically, after the smart card receives the first card data transmitted by the server, if the card writing data is encrypted, then there may be a case that the first card data cannot be acquired because of decryption failure occurring in a decryption process, which thus indirectly results in that the smart card fails to replace, except the original authentication key parameter, the original card data corresponding to the preset number with the first card data correspondingly; or a case that, the smart card acquires the first card data from a server side successfully, but fails to replace, except the original authentication key parameter, the original card data corresponding to the preset number with the first card data correspondingly. After these two cases occur, the smart card will perform processing like the latter case occurs by default, a specific operation includes transmitting the retransmitted card writing data request to the server via the preset number, so as to instruct the server to retransmit the first card data to the smart card. The retransmit card writing data request includes the card writing number.

The server reacquires the first card data corresponding to the card writing number according to the card writing number in the retransmit card writing data request, and transmits to the smart card.

Furthermore, after the step 304, further including:

S306, the smart card transmits a card writing success message to the server via the card writing number, so as to instruct the server to recycle the original card data corresponding to the preset number according to the card writing success message;

Specifically, after the smart card succeeds in replacing, except the original authentication key parameter, the original card data corresponding to the preset number with the first card data correspondingly, and replacing the original authentication key parameter in the original card data with the first authentication key parameter correspondingly, the smart card logs on to the mobile network via the card writing number written in, and transmits a card writing success message to the server through organizing an OTA short message transmission, so as to instruct the server to recycle the original card data corresponding to the preset number according to the card writing success message. After receiving the card writing success message, the server uses an ICCID corresponding to the preset number as an index to match and update a user database, and the original card data corresponding to the preset number is recycled.

According to the method for writing a card over the air provided in the present invention, a server receives a card writing request transmitted by a portal site, where the card writing request carries a preset number and a card writing number corresponding to a smart card to be written; the server acquires first card data corresponding to the card writing number according to the card writing number; the server transmits the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card, so as to enable the smart card to complete the card writing over the air. The solution can effectively solve a defect in the prior art that the preset number is inconvenient to be recycled caused by a one-to-two correspondence between one set of network authentication keys and two sets of IMSIs which is formed in a process of writing a card over the air via a preset number, during unfinished card issuance.

Persons of ordinary skill in the art may understand that, all or a part of the steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as an ROM, an RAM, a magnetic disk, or an optical disc.

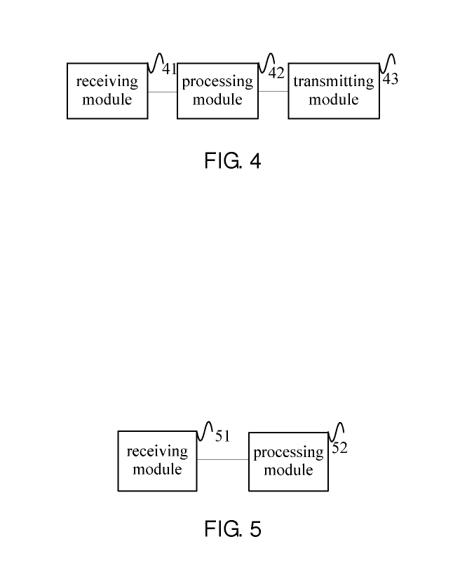

FIG. 4 is a schematic structural diagram of a server according to an embodiment of the present invention, the server may execute steps of the method for writing the card over the air as shown in FIG. 1, as shown in FIG. 4, the server specifically includes a receiving module 41, a processing module 42, and a transmitting module 43, where:

the receiving module 41 is configured to receive a card writing request transmitted by a portal site, where the card writing request carries a preset number and a card writing number corresponding to a smart card to be written;

the processing module 42 is configured to acquire first card data corresponding to the card writing number according to the card writing number;

the transmitting module 43 is configured to transmit the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card, so that the smart card completes card writing over the air.

Furthermore, when transmitting the first card data to the smart card according to the preset number, the transmitting module 43 may specifically transmit the first card data to the smart card by transmitting an over-the-air OTA short message.

Furthermore, after the transmitting module 43 transmits the first card data to the smart card according to the preset number, the receiving module 41 may also receive a retransmitted card writing data request transmitted by the smart card via the preset number, and instruct the transmitting module 43 to retransmit the first card data to the smart card;

Or, the receiving module 41 receives a card writing success message transmitted by the smart card via the card writing number, and instructs the processing module 42 to recycle the original card data corresponding to the preset number according to the card writing success message.

The original authentication key parameter specifically includes: an authentication key KI and a key sequence OPc corresponding to the preset number.

In the method steps in the embodiment as shown in FIG. 3, the method steps taking a server as an executive agent may be implemented through the server as shown in this embodiment, a principle of the method thereof will not be repeated herein.

A server provided in the present invention receives a card writing request transmitted by a portal site, where the card writing request carries a preset number and a card writing number corresponding to a smart card to be written; acquires first card data corresponding to the card writing number according to the card writing number; transmits the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card, so as to enable the smart card to complete the card writing over the air. The solution can effectively solve a defect in the prior art that the preset number is inconvenient to be recycled caused by a one-to-two correspondence between one set of network authentication keys and two sets of IMSIs which is formed in a process of writing a card over the air via a preset number, during unfinished card issuance.

FIG. 5 is a schematic structural diagram of a smart card according to an embodiment of the present invention. When being placed into a mobile phone for use with power, the smart card may execute the steps of the method for writing the card over the air as shown in FIG. 2, as shown in FIG. 5, the smart card specifically includes a receiving module 51 and a processing module 52, where:

the receiving module 51 is configured to receive first card data transmitted by a server via a preset number set in the smart card, where the smart card carries original card data, in which an original authentication key parameter is contained, corresponding to the preset number and a first authentication key parameter;

the processing module 52 is configured to replace, except the original authentication key parameter, the original card data corresponding to the preset number with the first card data correspondingly, and replace the original authentication key parameter with the first authentication key parameter correspondingly to complete card writing over the air.

Furthermore, when receiving first card data transmitted by a server via a preset number set in the smart card, the receiving module 51 may receive the first card data forwarded by the server via an over-the-air OTA short message.

Furthermore, the smart card as shown in this embodiment also includes a transmitting module, the transmitting module is configured to: if the processing module 52 fails to replace, except the original authentication key parameter, the original card data corresponding to the preset number with the first card data correspondingly, then transmit a retransmitted card writing data request to the server via the preset number, so as to instruct the server to retransmit the first card data to the receiving module 51.

Furthermore, the transmitting module is further configured to: after the processing module 52 replaces, except the original authentication key parameter, the original card data corresponding to the preset number with the first card data correspondingly, and replaces the original authentication key parameter with the first authentication key parameter correspondingly to complete the card writing over the air, transmit a card writing success message to the server via the card writing number to instruct the server to recycle the original card data corresponding to the preset number according to the card writing success message.

Furthermore, the original authentication key parameter specifically includes: an authentication key KI and a key sequence OPc corresponding to the preset number.

In the method steps of the embodiment as shown in FIG. 3, the method steps taking a smart card as an executive agent may be implemented through the smart card as shown in this embodiment, a principle of the method thereof will not be repeated herein.

A smart card provided in the preset invention receives first card data transmitted by a server via a preset number set in the smart card, where, besides an original authentication key parameter corresponding to the preset number, the smart card is also prestored with a first authentication key parameter; correspondingly replaces, except the original authentication key parameter, original card data corresponding to the preset number with the first card data, and correspondingly replaces the original authentication key parameter in the original card data with the first authentication key parameter to complete the card writing over the air. The solution can effectively solve a defect in the prior art that the preset number is inconvenient to be recycled caused by a one-to-two correspondence between one set of network authentication keys and two sets of IMSIs which is formed in a process of writing a card over the air via a preset number, during unfinished card issuance.

Finally, it should be noted that the foregoing embodiments are merely intended for describing technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some or all technical features thereof; however, these modifications or replacements do not make the essence of corresponding technical solutions depart from the scope of the technical solutions in the embodiments of the present invention.

What is claimed is:

1. A method for writing a card over the air, comprising:
receiving, by a server, a card writing request transmitted by a portal site, wherein the card writing request carries a preset number and a card writing number corresponding to a smart card to be written;
acquiring, by the server, first card data corresponding to the card writing number according to the card writing number;
transmitting, by the server, the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card to enable the smart card to complete card writing over the air.

2. The method according to claim 1, wherein, after the transmitting, by the server, the first card data to the smart card according to the preset number to instruct the smart card to correspondingly replace, except the original authentication key parameter, the original card data corresponding to the preset number with the first card data, and correspondingly replace the original authentication key parameter in the original card data with the first authentication key parameter presorted in the smart card, further comprising:
receiving, by the server, a retransmitted card writing data request transmitted by the smart card via the preset number, and retransmitting the first card data to the smart card; or,
receiving, by the server, a card writing success message transmitted by the smart card via the card writing number, and recycling the original card data corresponding to the preset number according to the card writing success message.

3. A method for writing a card over the air, comprising:
receiving, by a smart card, first card data transmitted by a server via a preset number set in the smart card, wherein the smart card carries original card data, in which an original authentication key parameter is contained, corresponding to the preset number and a first authentication key parameter;
replacing, by the smart card, except the original authentication key parameter, the original card data corresponding to the preset number with the first card data correspondingly, and replacing the original authentication key parameter with the first authentication key parameter correspondingly to complete card writing over the air.

4. The method according to claim 3, wherein, if the replacing, by the smart card, except the original authentication key parameter, the original card data corresponding to the preset number with the first card data correspondingly is failed, then transmitting, by the smart card, a retransmitted card writing data request to the server via the preset number to instruct the server to retransmit the first card data to the smart card.

5. The method according to claim 3, wherein, after the replacing, by the smart card, except the original authentication key parameter, the original card data corresponding to the preset number with the first card data correspondingly, and the replacing the original authentication key parameter with the first authentication key parameter correspondingly to complete the card writing over the air, further comprising:
transmitting, by the smart card, a card writing success message to the server via the card writing number to instruct the server to recycle the original card data corresponding to the preset number according to the card writing success message.

6. The method according to claim 4, wherein, after the replacing, by the smart card, except the original authentication key parameter, the original card data corresponding to the preset number with the first card data correspondingly, and the replacing the original authentication key parameter with the first authentication key parameter correspondingly to complete the card writing over the air, further comprising:
transmitting, by the smart card, a card writing success message to the server via the card writing number to instruct the server to recycle the original card data corresponding to the preset number according to the card writing success message.

7. A server, comprising:
a receiver, configured to receive a card writing request transmitted by a portal site, wherein the card writing request carries a preset number and a card writing number corresponding to a smart card to be written;
a processor, configured to acquire first card data corresponding to the card writing number according to the card writing number;
a transmitter, configured to transmit the first card data to the smart card according to the preset number to instruct the smart card to correspondingly replace, except an original authentication key parameter, original card data corresponding to the preset number with the first card data, and correspondingly replace the original authentication key parameter in the original card data with a first authentication key parameter presorted in the smart card to enable the smart card to complete card writing over the air.

8. The server according to claim 7, wherein, the receiver is further configured to receive a retransmitted card writing data request transmitted by the smart card via the preset number, and instruct the transmitter to retransmit the first card data to the smart card; or,
the receiver is further configured to receive a card writing success message transmitted by the smart card via the card writing number, and instruct the processor to recycle the original card data corresponding to the preset number according to the card writing success message.

9. A smart card, comprising:
a receiver, configured to receive first card data transmitted by a server via a preset number set in the smart card, wherein the smart card carries original card data, in which an original authentication key parameter is contained, corresponding to the preset number and a first authentication key parameter;
a processor, configured to replace, except the original authentication key parameter, the original card data corresponding to the preset number with the first card data correspondingly, and replace the original authentication key parameter with the first authentication key parameter correspondingly to complete card writing over the air.

10. The smart card according to claim 9, further comprising:
a transmitter, configured to: if the processor fails to replace, except the original authentication key parameter, the original card data corresponding to the preset number with the first card data correspondingly, transmit a retransmitted card writing data request to the server via the preset number to instruct the server to retransmit the first card data to the receiver.

11. The smart card according to claim 9, wherein, the transmitter is further configured to:
after the processor replaces, except the original authentication key parameter, the original card data corresponding to the preset number with the first card data correspondingly, and replaces the original authentication key parameter with the first authentication key parameter correspondingly to complete the card writing over the air, transmit a card writing success message to the server via the card writing number to instruct the server to recycle the original card data corresponding to the preset number according to the card writing success message.

12. The smart card according to claim 10, wherein, the transmitter is further configured to:
after the processor replaces, except the original authentication key parameter, the original card data corresponding to the preset number with the first card data correspondingly, and replaces the original authentication key parameter with the first authentication key parameter correspondingly to complete the card writing over the air, transmit a card writing success message to the server via the card writing number to instruct the server to recycle the original card data corresponding to the preset number according to the card writing success message.
